(19) United States
(12) Patent Application Publication
(10) Pub. No.: US 2019/0156042 A1
(43) Pub. Date: May 23, 2019

(54) METHOD, SYSTEM AND APPARATUS FOR GENERATING DOCUMENT FOR SHARING VULNERABILITY INFORMATION

(71) Applicant: KOREA INTERNET & SECURITY AGENCY, Naju-si (KR)

(72) Inventors: Hwan Kuk KIM, Naju-si (KR); Tae Eun KIM, Naju-si (KR); Dae Il JANG, Naju-si (KR); Chang Hun YU, Naju-si (KR); Young Nam SON, Naju-si (KR); Eun Hye KO, Naju-si (KR); Sa Rang NA, Naju-si (KR)

(73) Assignee: KOREA INTERNET & SECURITY AGENCY, Naju-si (KR)

(21) Appl. No.: 15/890,713

(22) Filed: Feb. 7, 2018

(30) Foreign Application Priority Data
Nov. 21, 2017 (KR) 10-2017-0155838

(51) Int. Cl. G06F 21/57; G06F 17/30

(52) U.S. Cl. CPC G06F 21/577; G06F 2221/034; G06F 17/30011; G06F 17/30569

(57) ABSTRACT

Provided are a method, apparatus and system for converting vulnerability information collected from various sources of vulnerability information into a format that can be easily shared. A vulnerability information providing system according to an embodiment includes: a vulnerability information analysis system which collects vulnerability information from a source of vulnerability information and collects observed information related to a device connected to a network; a vulnerability information sharing apparatus which generates a document for sharing vulnerability information by converting known vulnerability information into a predefined format, converting observed information obtained by observing a device connected to the network into a predefined format, and generating relationship information between the vulnerability information and the observed information; and a vulnerability database which stores the document for sharing vulnerability information and provides the document for sharing vulnerability information to a device requesting the vulnerability information.

This application claims the benefit of Korean Patent Application No. 10-2017-0155838, filed on Nov. 21, 2017, in the Korean Intellectual Property Office, the disclosure of which is incorporated herein by reference in its entirety.

### BACKGROUND

### 1. Field

The present inventive concept relates to a method, system and apparatus for generating a document for sharing vulnerability information, and more particularly, to a method, system and apparatus for generating a document for sharing vulnerability information in a format suitable for data exchange.

### 2. Description of the Related Art

The contents described in this section merely provide background information for embodiments of the inventive concept, but do not describe known technologies.

Security vulnerabilities inherent in software can easily be exploited to attack computer systems. Attackers can identify vulnerable web services and conduct malicious activities by using Internet scanning tools. Therefore, security administrators need to be aware of and quickly respond to known vulnerabilities. In particular, with the widespread of Internet of Things (IoT) devices in recent years, the number of devices connected to the Internet is rapidly increasing. Therefore, it is necessary to quickly identify and analyze security vulnerabilities of numerous computer systems connected to the Internet. Determining how to respond to security vulnerabilities by identifying and analyzing the security vulnerabilities in order to prevent security incidents arising from the security vulnerabilities is called vulnerability analysis.

To easily share known security vulnerabilities information, vulnerability information is provided from various sources of vulnerability information. For example, the National Vulnerability Database (NVD) provides Common Vulnerabilities and Exposures (CVE) information. The CVE information provides a way to refer to security vulnerability information of software packages. The CVE information includes Common Vulnerabilities and Exposures Identifier (CVE-ID), Overview, Common Vulnerability Scoring System (CVSS), Common Platform Enumeration (CPE), and Common Weakness Enumeration (CWE) (see http://nvd.nist.gov/).

The vulnerability information can also be found at http://vuldb.com/(VulDB) or at http://www.securityfocus.com/bid/(Bugtraq). In addition, manufacturers of devices connected to the Internet post device firmware version information and security patch information in various forms on their web pages (see http://iptime.com/iptime/?page_id=126 and http://netiskorea.com/atboard.php?grp1=support&grp2=download).

The vulnerability information provided by the sources of vulnerability information is updated frequently. In addition, the type, firmware, etc. of devices is various and new version of it could be published frequently. For quick response to vulnerabilities in order to maintain security in the IoT environment, there is a need to provide a vulnerability document through which can be easily shared and analyzed.

### SUMMARY

Aspects of the inventive concept provide a method and apparatus for converting vulnerability information collected from various sources of vulnerability information into a format that can be easily shared.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

According to an aspect of the inventive concept, there is provided a vulnerability information providing system including: a vulnerability information analysis system which collects vulnerability information from a source of vulnerability information and collects observed information including a device related to the vulnerability; a vulnerability information sharing apparatus which generates a document for sharing vulnerability information by converting the vulnerability information into a predefined format, converting the observed information obtained by observing a device connected to a network into a predefined format, and generating relationship information between the vulnerability information and the observed information; and a vulnerability database which stores the document for sharing vulnerability information and provides the document for sharing vulnerability information to a device requesting the vulnerability information.

According to other aspect of the inventive concept, the vulnerability information sharing apparatus adds additional properties for vulnerability information, which does not match predetermined properties of Structured Threat Information Expression (STIX) object, to an STIX object that defines the predetermined properties.

According to other aspect of the inventive concept, the predetermined properties comprise vulnerability ID, reference information, description information, created date information and modified date information, and the additional properties comprise vulnerability type, vulnerability score and affected products.

According to other aspect of the inventive concept, the vulnerability information analysis system determines the source of vulnerability information, creates a rule for collecting a vulnerability information corresponding to the vulnerability information provided from the source, and collects the vulnerability information according to the rule.

According to other aspect of the inventive concept, the vulnerability information sharing apparatus generates an STIX document comprising the vulnerability information converted into the predefined format, and the vulnerability database sets the STIX object as a node and stores a graph showing the relationship between the node and another node.

According to other aspect of the inventive concept, the format of the document for sharing vulnerability information is based on STIX which is a language used to exchange Cyber Threat Intelligence (CTI).

According to an aspect of the inventive concept, there is provided a method of generating a document for sharing vulnerability information including: converting known vulnerability information into a predefined format; converting observed information, which comprises information about a device related to the vulnerability information, into a predefined format; generating relationship information between the vulnerability information and the observed information; and generating a document for sharing vulnerability information comprising the converted vulnerability information, the converted observed information and the relationship information.

According to other aspect of the inventive concept, the method further comprises adding additional properties for vulnerability information, which does not match predetermined information sharing properties of STIX object, to an STIX object that defines the predetermined information sharing properties.

According to other aspect of the inventive concept, the converting of the vulnerability information into the predefined format comprises: generating basic vulnerability information for the predetermined properties based on the vulnerability information; converting the vulnerability information into additional vulnerability information according to the additional properties; and generating a vulnerability STIX object and adding the basic vulnerability information and the additional vulnerability information to the vulnerability STIX object.

According to other aspect of the inventive concept, the converting of the vulnerability information into the additional properties comprises extracting a Common Platform Enumeration (CPE) ID, Common Vulnerabilities Scoring System (CVSS) score information and a Common Weakness Enumeration ID (CWE-ID) from the vulnerability information.

According to other aspect of the inventive concept, the generating of the basic properties comprises: generating an object ID; extracting date information and description information from the vulnerability information; and generating reference information.

According to other aspect of the inventive concept, the generating of the reference information comprises: generating a name of a source of vulnerability information which provides the vulnerability information; and obtaining a Uniform Resource Locator (URL) which provides the vulnerability information.

According to an aspect of the inventive concept, there is provided a vulnerability information sharing apparatus comprising: a processor; a storage device which stores a program; and a memory which stores a plurality of operations to be executed by the processor, wherein the operations comprise: an operation of converting known vulnerability information into a predefined format; an operation of converting observed information, which comprises information about a device related to the vulnerability information, into a predefined format; an operation of generating relationship information between the vulnerability information and the observed information; and an operation of generating a document for sharing vulnerability information comprising the converted vulnerability information, the converted observed information and the relationship information.

According to an aspect of the inventive concept, there is provided a computer program recorded on a non-transitory computer-readable medium and, when instructions of the computer program are executed by a processor of a server, performing operations of: converting known vulnerability information into a predefined format; converting observed information, which comprises information about a device related to the vulnerability information, into a predefined format; generating relationship information between the vulnerability information and the observed information; and generating a document for sharing vulnerability information comprising the converted vulnerability information, the converted observed information and the relationship information.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates an example of vulnerability information provided by a source of vulnerability information;

FIG. 2 illustrates a structure in which a vulnerability information sharing apparatus operates according to an embodiment;

FIG. 3 illustrates a vulnerability information providing system according to an embodiment;

FIG. 4 illustrates the configuration of a vulnerability information sharing apparatus according to an embodiment;

FIG. 5 illustrates a process of generating a document for sharing vulnerability information according to an embodiment;

FIG. 6 illustrates a process of converting vulnerability information according to an embodiment;

FIG. 7 illustrates an example of program code that adds converted vulnerability information to an information sharing object according to an embodiment;

FIG. 8 illustrates a process of generating reference information according to an embodiment;

FIG. 9 illustrates a process of extracting additional vulnerability information from vulnerability information according to an embodiment;

FIG. 10 illustrates the configuration of an information sharing object including converted vulnerability information according to an embodiment;

FIG. 11 illustrates a process of generating a document for sharing vulnerability information that reflects changed vulnerability information according to an embodiment when vulnerability information is not information about a new vulnerability;

FIG. 12 illustrates a process of converting observed information according to an embodiment;

FIG. 13 illustrates an example of program code that adds converted observed information to an information sharing object according to an embodiment;

FIG. 14 illustrates the configuration of an information sharing object including converted observed information according to an embodiment;

FIG. 15 illustrates the configuration of an information sharing object expressing properties of software or a software product based on observed information according to an embodiment;

FIG. 16 illustrates a process of generating relationship information according to an embodiment;

FIG. 17 illustrates an example of program code that adds relationship information to an information sharing object according to an embodiment;

FIG. 18 illustrates the configuration of an information sharing object including converted relationship information according to an embodiment; and

FIG. 19 illustrates an example of a graph constructed based on information sharing objects according to an embodiment.

### DETAILED DESCRIPTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

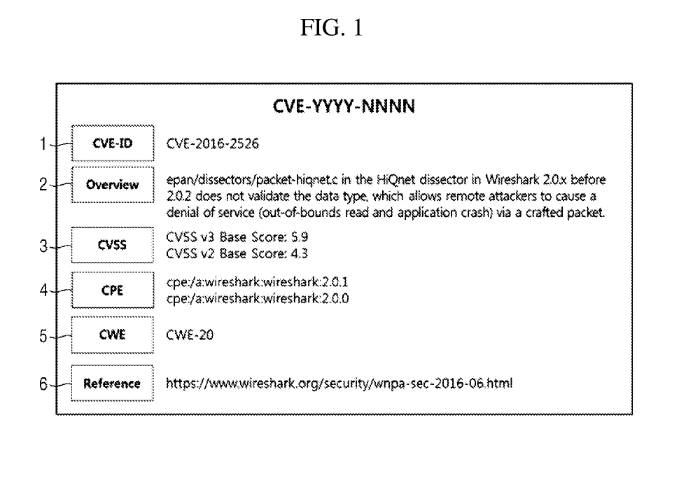

FIG. 1 illustrates an example of known vulnerability information provided by a source of vulnerability information. In particular, the vulnerability information illustrated in FIG. 1 is an example of Common Vulnerabilities and Exposures (CVE) information provided by the National Vulnerability Database (NVD). The CVE information includes all or part of CVD identifier (CVE-ID) 1, Overview 2, Common Vulnerability Scoring System (CVSS) 3, Common Platform Enumeration (CPE) 4, Common Weakness Enumeration (CWE) 5, and Reference 6. The Overview 2 may be composed of “place where a vulnerability was discovered,” “(in) related software product names,” “(when) conditions of the vulnerability occurrence,” “(allow) attacker type,” “(to) results of attack,” “(via) means of attack,” “(aka) vulnerability title in the reference site,” and “(a different vulnerability than) other CVE-IDs.” The Overview 2 can be expressed by a term such as Description.

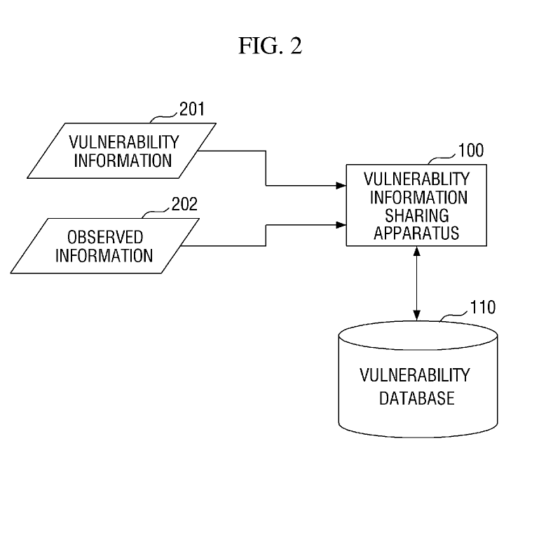

FIG. 2 illustrates a structure in which a vulnerability information sharing apparatus 100 operates according to an embodiment.

The vulnerability information sharing apparatus 100 according to the embodiment may obtain vulnerability information 201 and observed information 202. According to an embodiment, the vulnerability information sharing apparatus 100 may obtain the vulnerability information 201 by downloading a vulnerability file including the vulnerability information 201 through a network. For example, the NVD provides the vulnerability information 201 through a spreadsheet file, an XML file, a Javascript Object Notation (JSON) format file, or the like. As used herein, the vulnerability information 201 refers to information indicating properties of a vulnerability, such as vulnerability identification information (e.g., the CVE-ID 1), vulnerability overview (e.g., the Overview 2), vulnerability score (e.g., the CVSS score 3), vulnerability type (e.g., the CWE 5), and reference information (e.g., the Reference 6).

In addition, the observed information 202, as used herein, refers to information about a device that has been observed to be affected by the vulnerability. According to an embodiment, the observed information 202, like the CPE 4 illustrated in FIG. 1, may be provided from a source of vulnerability information, together with the vulnerability information 201. According to an embodiment, the observed information 202 refers to device information obtained as a result of performing a service scan of devices connected to the network. The observed information 202 may include information representing hardware, operating system and application version information of an observed device in a predetermined format. For example, the observed information 202 may include a CPE-ID of a device.

Here, the vulnerability information 201 and the observed information 202 need to be shared quickly so that security measures against the vulnerability can be established and applied. To this end, the vulnerability information sharing apparatus 100 may convert the vulnerability information 201 and the observed information 202 into a predefined format. The converted vulnerability information 201 and observed information 202 may be stored in a vulnerability database 110 as a vulnerability information sharing document.

For example, the vulnerability information sharing apparatus 100 may generate a document for sharing vulnerability information by converting the vulnerability information 201 and the observed information 202 into a Structured Threat Information Expression (STIX) format. The STIX format is a language used to exchange Cyber Threat Intelligence (CTI) and is a serialization method. By storing the vulnerability information 201 and the observed information 202 in the STIX format, the vulnerability information sharing apparatus 100 can consistently share the vulnerability information 201 and the observed information 202 in a computer readable manner. In addition, a device that shares the vulnerability information 201 and the observed information 202 can predict or respond to the source of a computer-based attack more quickly and effectively.

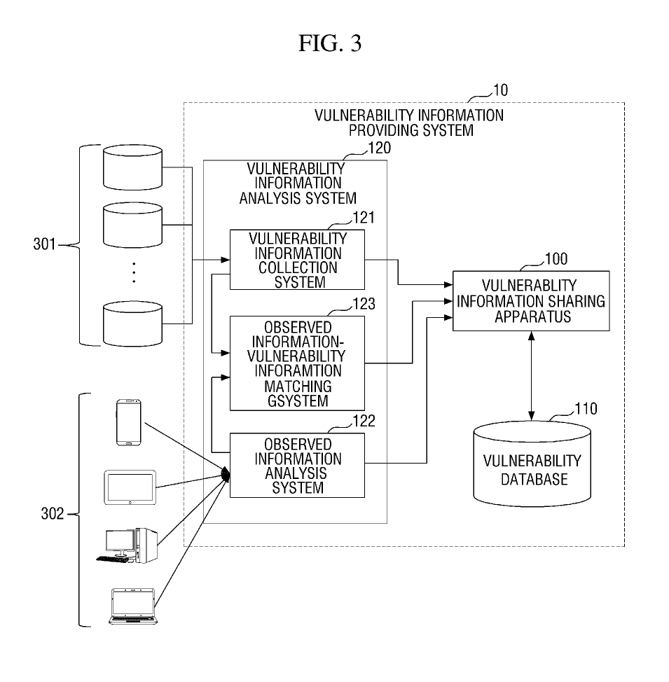

FIG. 3 illustrates a vulnerability information providing system 10 according to an embodiment. FIG. 3 is only an embodiment, and the structure illustrated in FIG. 3 can be changed to another structure performing the same function. Alternatively, some of the components of the vulnerability information providing system 10 can be replaced with other components, or the vulnerability information providing system 10 can further include other components. A vulnerability information sharing apparatus 100 may be configured to include a computing device. In addition, a vulnerability information analysis system 120 may be configured to include a computing device.

The vulnerability information providing system 10 according to the embodiment may include the vulnerability information analysis system 120, the vulnerability information sharing apparatus 100, and a vulnerability database 110.

The vulnerability information analysis system 120 may collect vulnerability information from sources 301 of vulnerability information. In addition, the vulnerability information analysis system 120 may collect observed information obtained by observing devices 302 connected to the network through a service scan of the devices 302. According to an embodiment, the vulnerability information analysis system 120 may include a vulnerability information collection system 121, an observed information analysis system 122, and an observed information-vulnerability information matching system 123. The vulnerability information collection system 121 may collect vulnerability information from the sources 301 of vulnerability information. For example, the vulnerability information collection system 121 may select one of the sources 301 of vulnerability information. The vulnerability information collection system 121 may download a data file including vulnerability information from the selected source of vulnerability information. Here, the data file refers to a file storing vulnerability information and structured in the form of an XML file, a spreadsheet file, a JSON format file, or the like. Alternatively, when the selected source of vulnerability information is described on a web page, the vulnerability information collection system 121 may extract vulnerability information by analyzing the web page (for example, by parsing the web page source code).

According to an embodiment, when a source of vulnerability information from which vulnerability information is to be collected is determined, the vulnerability information collection system 121 may create a rule for collecting a vulnerability information corresponding to the determined source of vulnerability information. Here, the rule for collecting a vulnerability information may define a process in which the vulnerability information collection system 121 obtains vulnerability information. For example, the rule for collecting a vulnerability information may define a Universal Resource Locator (URL) necessary for downloading a data file including vulnerability information, the position of the vulnerability information corresponding to information sharing items in the data file, etc., so that the vulnerability information collection system 121 can obtain the vulnerability information from the data file. For another example, the rule for collecting a vulnerability information may define a URL of a web page where vulnerability information is provided and a location where the vulnerability information is displayed (for example, at the top of the web page or after a specific word/phrase). By collecting the vulnerability information using the rule for collecting a vulnerability information as described above, it is possible to collect the vulnerability information from the various sources 301 of vulnerability information without having to generate execution code for collecting the vulnerability information whenever a source of vulnerability information is changed. In addition, when a format in which one of the sources of vulnerability information 301 provides the vulnerability information is changed, it is possible to collect the vulnerability information from the changed source of vulnerability information by simply changing the rule for collecting a vulnerability information without modifying the entire operation process of the vulnerability information collection system 121. The rule for collecting a vulnerability information may be stored in a storage medium or database of the vulnerability information analysis system 120. Alternatively, the rule for collecting a vulnerability information may be stored in a separate storage medium or retrieved through the network.

The observed information analysis system 122 may generate observed information by observing information about the devices 302 connected to the network. According to an embodiment, the observed information analysis system 122 may send packets to random IP addresses over the network and generate observed information based on responses to the packets. The observed information may include, for example, the type, firmware version, operating system version, etc. of a device connected to the network. In FIG. 3, the observed information analysis system 122 generates observed information by observing information about the devices 302 connected to the network. However, according to an embodiment, the vulnerability information providing system 100 may receive observed information from the sources 301 of vulnerability information, together with vulnerability information.

The observed information-vulnerability information matching system 123 may determine observed information and vulnerability information that match each other. When vulnerability information has information (e.g., CPE) about a device having a vulnerability, the observed information-vulnerability information matching system 123 may determine the vulnerability information that matches observed information.

The vulnerability information sharing apparatus 100 may convert each of the vulnerability information collected by the vulnerability information collection system 121, the observed information collected by the observed information analysis system 122, and the relationship between the observed information and the vulnerability information matched by the observed information-vulnerability information matching system 123 into a predefined format and generate a document for sharing vulnerability information based on the converted information. The document for sharing vulnerability information may be stored in the vulnerability database 110.

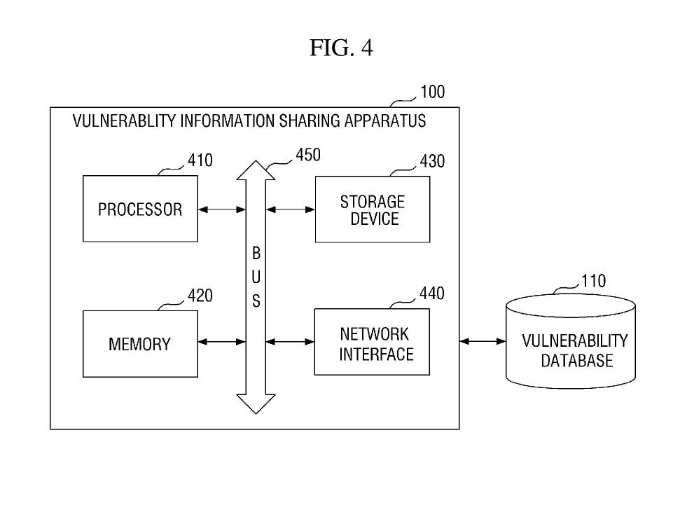

FIG. 4 illustrates the configuration of a vulnerability information sharing apparatus 100 according to an embodiment. The vulnerability information sharing apparatus 100 according to the embodiment may include hardware components as illustrated in FIG. 4.

The vulnerability information sharing apparatus 100 may include a processor 410 for executing an instruction, a storage device 430 for storing a program including instructions, a memory 420, and a network interface 440 for data exchange with an external device. In addition, the vulnerability information sharing apparatus 100 may further include a system bus 450 that serves as a path for transferring data between the components. The memory 420 may store operations of a process performed by the vulnerability information sharing apparatus 100. The processor 410 may control the operation of the vulnerability information sharing apparatus 100 by executing the operations stored in the memory 420.

A program stored in the storage device 430 may enable the vulnerability information sharing apparatus 100 to perform the process described in the present specification.

Although the vulnerability database 110 is separated from the vulnerability information sharing apparatus 100 in FIG. 4, it can also be included in the vulnerability information sharing apparatus 100 depending on embodiments.

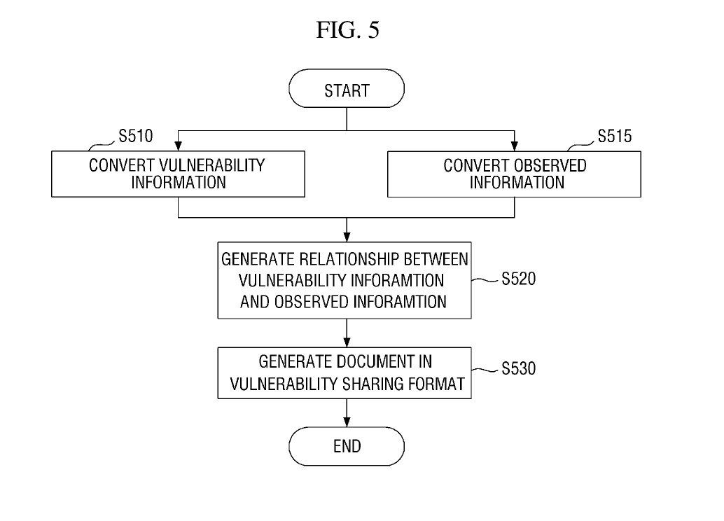

FIG. 5 illustrates a process in which the vulnerability information sharing apparatus 100 generates a document for sharing vulnerability information according to an embodiment. The vulnerability information sharing apparatus 100 according to the embodiment may generate a document by converting vulnerability information and observed information into a predefined format.

The predefined format may be composed of predetermined information sharing items. In addition, if a CPE-ID included in observed information is converted into the predefined format, it may be configured in the form of CPE:2.3:part:vendor:product:version:update:edition:language:sw_edition:target_sw:target_hw:other. In the above example CPE-ID, “part” indicates a classification of software, such as an application, an operating system, or a hardware device. As used herein, “software” may include a software product. “Vendor” indicates the name of a supplier of the software. “Product” may refer to the name of a product. “Version” may refer to the version of the software. “Updated” may refer to the update, service pack or point release of the product. “Edition” may refer to the edition of the product. “Language” may refer to a programming language supported by the software. “Sw_edition” may refer to the software edition of the product. “Target_sw” may indicate the characteristics of the software computing environment in which the product operates. “Target_hw” may indicate an instruction set architecture. Here, “vendor,” “product,” “version,” and “language” can be expressed using the predetermined information sharing items. However, it is difficult to express “update,” “edition,” “sw-edition,” “target_sw,” “target_hw,” etc. using the predetermined information sharing items.

Therefore, the format of information needs to be converted as described in this specification.

In operation S510, the vulnerability information sharing apparatus 100 may convert vulnerability information into a predefined format. In addition, in operation S515, the vulnerability information sharing apparatus 100 may convert observed information into a predefined format.

In operations S510 and S515, the vulnerability information sharing apparatus 100 may convert the vulnerability information and the observed information into the predefined format by using an information sharing object of the predefined format. The information sharing object may define predetermined information sharing items according to the predefined format. For example, when the predefined format is the STIX format, the information sharing object of the predefined format may be an STIX domain object(STIX object). The STIX domain object defines set, attack pattern, campaign, course of action, ID, indicator, intrusion set, malware, observed data, report, threat actor, tool and vulnerability. According to this example, the vulnerability information sharing apparatus 100 may convert a vulnerability ID, reference information, description information, created date information, modified date information, etc. included in the vulnerability information into the form of the STIX domain object.

Next, in operation S520, the vulnerability information sharing apparatus 100 may generate the relationship between the vulnerability information and the observed information. That is, information about an observed device related to the vulnerability information may be determined.

Then, in operation S530, the vulnerability information sharing apparatus 100 may generate a document in the vulnerability predefined format based on the converted vulnerability information, the converted observed information, and the relationship between the vulnerability information and the observed information. The vulnerability information sharing apparatus 100 may store the converted vulnerability information, the converted observed information and the relationship between the vulnerability information and the observed information in the form of a graph database.

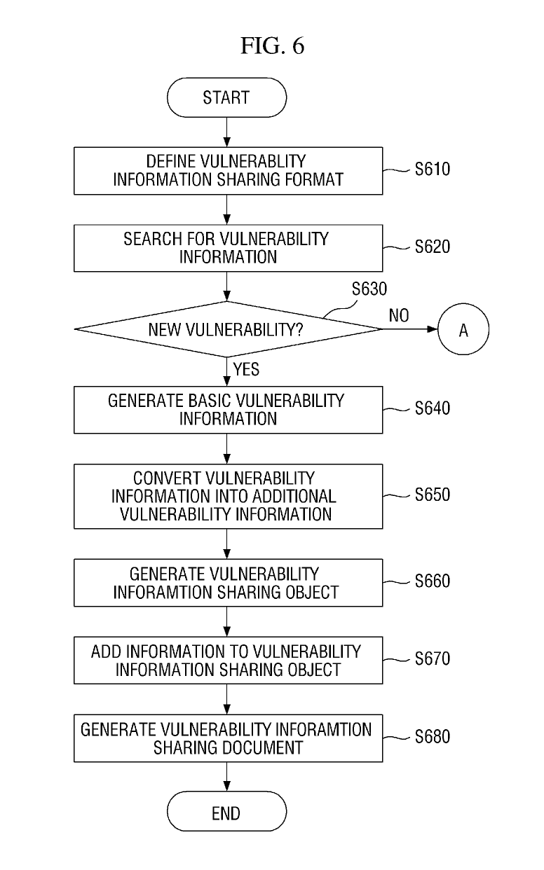

The process in which the vulnerability information sharing apparatus 100 converts the vulnerability information in operation S510 of FIG. 5 will now be described in more detail with reference to FIG. 6.

Referring to FIG. 6, in operation S610, the vulnerability information sharing apparatus 100 may define a vulnerability predefined format.

The predefined format may be composed of predetermined information sharing items. For this reason, when vulnerability information, observed information and relationship information between the vulnerability information and the observed information are converted into the predefined format, only part of the information can be expressed. For example, when the CVE information is converted into the STIX format, information such as the CVE ID 1, the Reference 6, the Overview 2, published date and last modified date in the CVE information can be expressed as a name item, an external_references item, a description item, a created date item and a modified date item of the STIX format. However, it is difficult to express the CPE 4, the CWE 5 and the CVSS 3 included in the CVE information by using the predetermined information sharing items included in the STIX format.

Therefore, according to an embodiment, the vulnerability information sharing apparatus 100 may additionally define additional items (such as the CPE 4, the CWE 5 and the CVSS 3) for vulnerability information, which does not match the predetermined information sharing items, in an information sharing object.

Next, in operation S620, the vulnerability information sharing apparatus 100 may check whether vulnerability information to be converted is included in a previously generated vulnerability information sharing document. For example, the vulnerability information sharing apparatus 100 may check whether there is a document for sharing vulnerability information having a CVE-ID included in the vulnerability information.

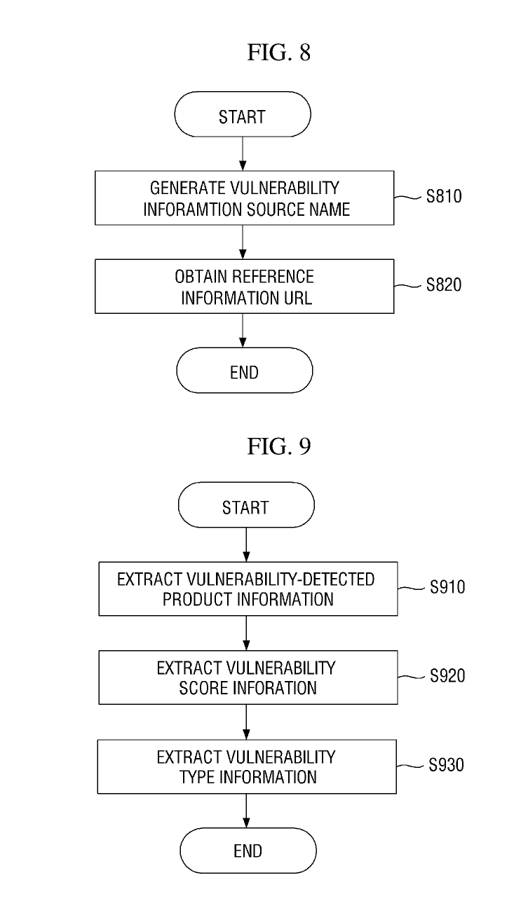

If it is determined in operation S630 that the vulnerability information to be converted is a new vulnerability, that is, if the vulnerability information is not found, the vulnerability information sharing apparatus 100 may generate basic vulnerability information corresponding to the predetermined information sharing items based on the vulnerability information in operation S640. Here, the predetermined information sharing items may be properties that are essentially included in the information sharing-object. For example, in operation S640, the vulnerability information sharing apparatus 100 may generate an object ID used to identify the information sharing object. The object ID may be configured in a UUIDv4 format (see section 4.4 of the RFC 4122 standard) of ‘object type—8 digit hexadecimal number-4 digit hexadecimal number-4 digit hexadecimal number-4 digit hexadecimal number-12 digit hexadecimal number. Here, each hexadecimal number may be assigned a randomly generated value. In addition, in operation S640, the vulnerability information sharing apparatus 100 may extract date information from the vulnerability information and convert the extracted date information into a format defined for a predetermined information sharing item. For example, published_date information and updated_date information included in the vulnerability information may be converted into a format according to a created_date item and a modified_date item of the information sharing object. Here, the created_date item and the modified_date item may be (as a result of “in” analysis) defined in the form of YYYY-MM-DDTHH:mm:ss[.s+]Z (for example, 2016-07-21T23:03:00+09:00 (in the STIX standard). In addition, the vulnerability information sharing apparatus 100 may generate reference information (external reference information) from the vulnerability information in operation S640. To generate the reference information, the vulnerability information sharing apparatus 100 may perform the process of FIG. 8.

Next, in operation S650, the vulnerability information sharing apparatus 100 may convert the vulnerability information into additional vulnerability information. Here, the additional vulnerability information refers to information added to the additional items. For example, the additional vulnerability information may include CPE-ID, CVSS score, and vulnerability type. Here, the vulnerability information sharing apparatus 100 may generate an information sharing object that includes the predetermined information sharing items and the additional items for the vulnerability information that does not match the predetermined information sharing items. That is, the vulnerability information sharing apparatus 100 may add the additional items for the vulnerability information, which does not match the predetermined information sharing items, to the information sharing object.

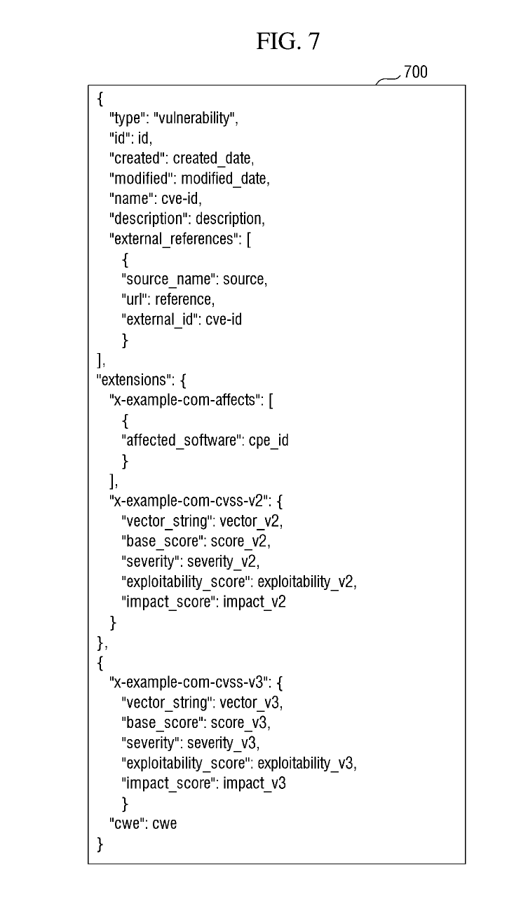

Next, in operation S660, the vulnerability information sharing apparatus 100 may generate an information sharing object of the vulnerability predefined format. In operation S670, the vulnerability information sharing apparatus 100 may add the converted vulnerability information to the information sharing object. For example, in operation S670, the vulnerability information may be added to the information sharing object according to the code illustrated in FIG. 7. Then, the vulnerability information sharing apparatus 100 may generate the information sharing object as a document for sharing vulnerability information in operation S680.

FIG. 8 illustrates a process of generating reference information according to an embodiment. According to an embodiment, the reference information may include a name of a source of vulnerability information and a reference information URL.

Referring to FIG. 8, the vulnerability information sharing apparatus 100 may generate a name of a source of vulnerability information in operation S810. The name of the source of vulnerability information is information indicating a source of vulnerability information that provides vulnerability information. For example, if vulnerability information to be included in a sharing document is the CVE information recorded in a file received from the NVD, the name of the source of vulnerability information name may be ‘cve.’

In addition, the vulnerability information sharing apparatus 100 may obtain a reference information URL in operation S820. The reference information URL is a URL indicating the location of information that can be referred to in connection with the vulnerability information.

The source of vulnerability information name generated in operation S810 and the reference information URL obtained in operation S820 may be added to the information sharing object.

FIG. 9 illustrates a process of extracting additional vulnerability information from vulnerability information according to an embodiment. According to an embodiment, the additional vulnerability information may include vulnerability-detected product information, vulnerability score information, and vulnerability type information.

In operation S910, the vulnerability information providing system 10 according to the embodiment may extract vulnerability-detected product information from vulnerability information. The vulnerability-detected product information is information about a product (for example, software) related to a vulnerability. For example, the vulnerability-detected product information may be CPE information.

In addition, the vulnerability information providing system 10 may extract vulnerability score information from the vulnerability information in operation S920. The vulnerability score information is information indicating the degree of danger of a vulnerability by giving a score to the vulnerability. According to an embodiment, the vulnerability information providing system 10 may extract a vector string, a base score, severity, an exploitability score, and an impact score from the vulnerability information and add the vector string, the base score, the severity, the exposure score and the impact score to vector, score, severity, exploitability and impact items of the information sharing object. Here, the vector, score, severity, exploitability and impact items may be included in the additional items defined additionally in operation S610.

In addition, the vulnerability information providing system 10 may extract vulnerability type information from the vulnerability information in operation S930. The vulnerability type may refer to information that indicates the type of a vulnerability. Here, the vulnerability information providing system 10 may extract the vulnerability type information in a predetermined form (for example, in the form of ‘CWE-number’). According to an embodiment, the vulnerability information providing system 10 may use a vulnerability information classification model to classify the vulnerability information. When the vulnerability information is input, the vulnerability information classification model may classify the type of a vulnerability included in the vulnerability information and output information about the type of the vulnerability in a predetermined form. For example, if the vulnerability information includes the word ‘buffer error’ and vulnerability type code for the buffer error is 119, the vulnerability information classification model may output ‘CWE-119’ as the vulnerability type information.

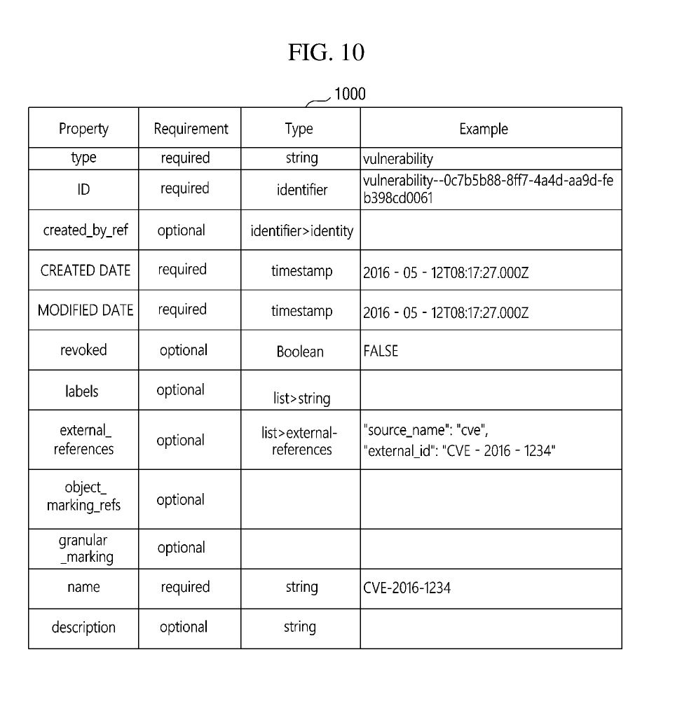

FIG. 10 illustrates the configuration of an information sharing object including converted vulnerability information according to an embodiment.

According to an embodiment, an information sharing object including vulnerability information may be configured to include items included in a list 1000 of FIG. 10. However, FIG. 10 is only an embodiment.

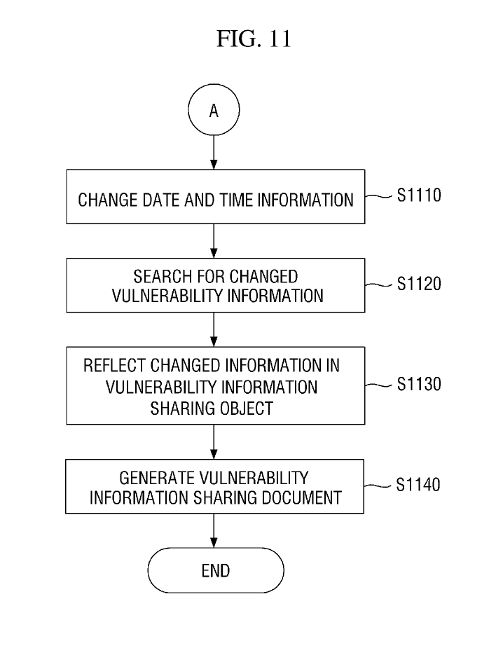

FIG. 11 illustrates a process of generating a document for sharing vulnerability information that reflects changed vulnerability information according to an embodiment when vulnerability information is not information about a new vulnerability.

Referring to FIG. 11, in operation S1110, the vulnerability information sharing apparatus 100 may modify modified date information, among date information of a previously generated information sharing object, based on update information of vulnerability information. Then, in operation S1120, the vulnerability information sharing apparatus 100 may determine whether there is changed vulnerability information by comparing the newly obtained vulnerability information with information recorded in the previously generated information sharing object.

If there is the changed vulnerability information, the vulnerability information sharing apparatus 100 may reflect the changed vulnerability information in the previously generated information sharing object for the vulnerability information in operation S1130. Then, the vulnerability information sharing apparatus 100 may generate the information sharing object, which reflects the changed vulnerability information, as an information sharing document about the vulnerability information in operation S1140.

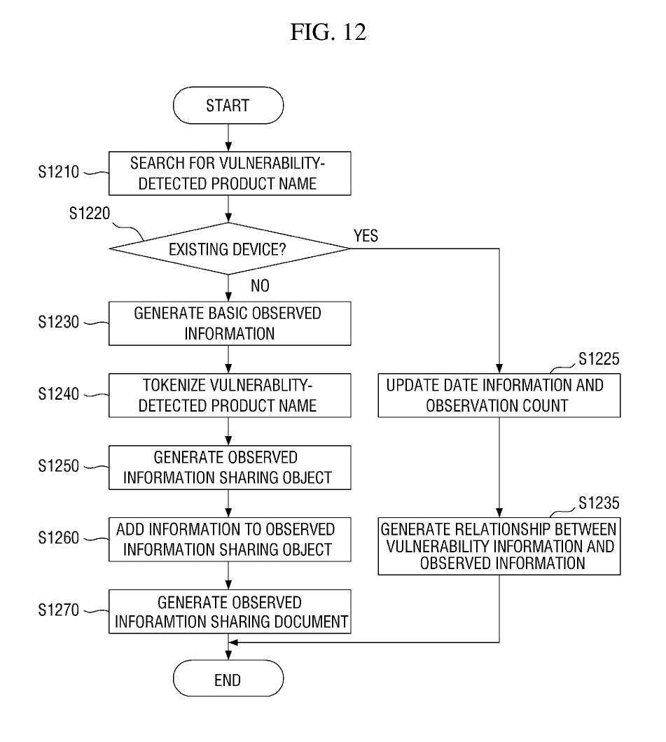

FIG. 12 illustrates a process of converting observed information according to an embodiment.

In operation S1210, the vulnerability information sharing apparatus 100 according to the embodiment may search for a vulnerability-detected product name, which is included in obtained observed information, in previously generated information sharing documents about observed information. If an information sharing document including the vulnerability-detected product name is found, the vulnerability information sharing apparatus 100 may determine in operation S1220 that the obtained observed information is information about the existing device. When determining that the obtained observed information is information about the existing device, the vulnerability information sharing apparatus 100 may update the date information (e.g., modified date) and observation count of an information sharing object included in the found information sharing document in operation S1225. The observation count indicates how much observed information about the same device has been observed. Next, the vulnerability information sharing apparatus 100 may generate the relationship between vulnerability information and the newly obtained observed information and add information about the generated relationship to the found information sharing document about the observed information.

If it is determined that the obtained observed information is about a new device, the vulnerability information sharing apparatus 100 may generate basic observed information based on the observed information in operation S1230. The basic observed information may refer to information corresponding to predetermined information sharing items in a predefined format related to the observed information. For example, the vulnerability information sharing apparatus 100 may generate an object ID in operation S1230 and convert date and time information according to the predefined format (for example, convert the published date into the created date and convert the update date into the modified date).

In addition, the vulnerability information sharing apparatus 100 may store a vulnerability-detected product name ID included in the observed information. According to an embodiment, the vulnerability product name ID may be a CPE-ID that complies with a CPE format. Like the above-described example CPE-ID (CPE:2.3:part:vendor:product:version:update:edition:language:sw_edition:target_sw:target_hw:other), a CPE-ID may be configured according to the CPE format by connecting various types of information about the device and delimiting the various types of information using “colons (:)” as delimiters. In operation S1240, the vulnerability information sharing apparatus 100 according to the embodiment may tokenize the CPE-ID delimited by the delimiters. According to the above-described example CPE-ID, the vulnerability information sharing apparatus 100 may determine third information among the various types of information delimited by the delimiters as “part,” fourth information as “vendor,” and fifth information as “product.”

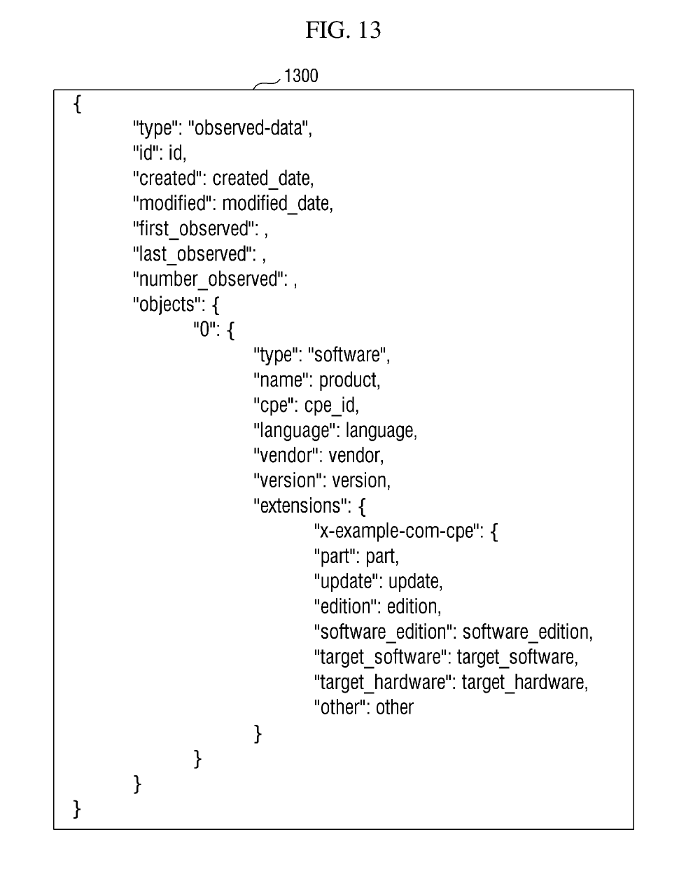

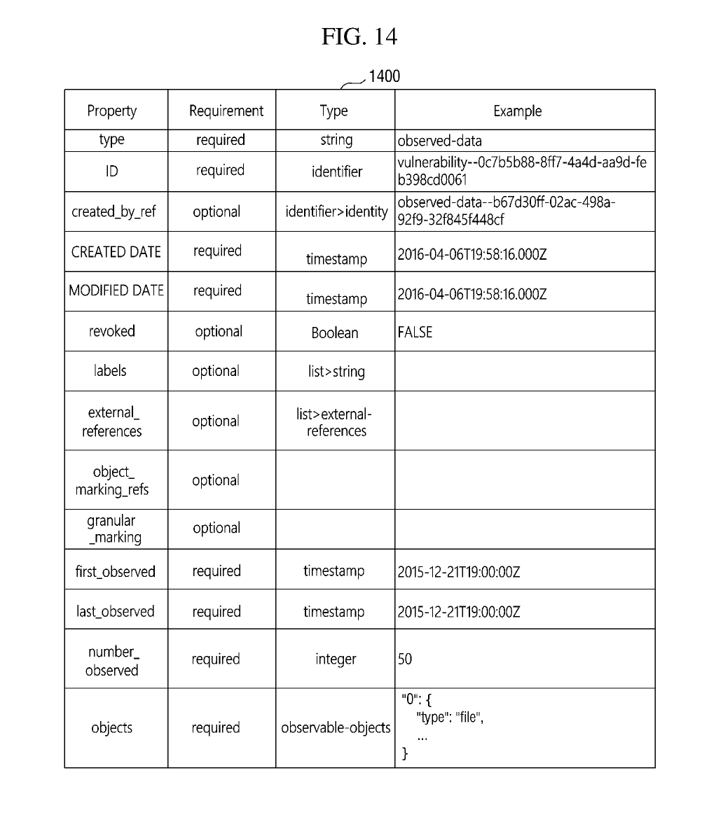

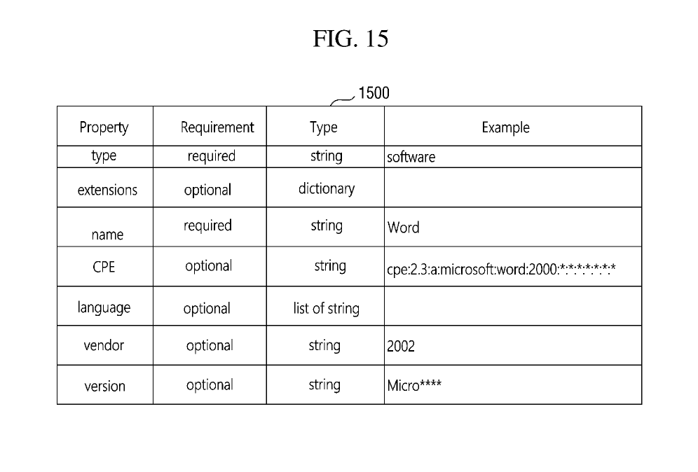

Next, in operation S1250, the vulnerability information sharing apparatus 100 may generate an information sharing object for sharing the observed information. Here, the vulnerability information sharing apparatus 100 may generate an information sharing object including the predetermined information sharing items and additional items for observed information that does not match the predetermined information sharing items. That is, the vulnerability information sharing apparatus 100 may add the additional items for the observed information, which does not match the predetermined information sharing items, to the information sharing object. For example, an information sharing object including items 1400 illustrated in FIG. 14 may be generated. Alternatively, an information sharing object including items 1500 representing advanced properties associated with software as illustrated in FIG. 15 may be generated. Of the items 1400 and 1500 illustrated in FIGS. 14 and 15, required items may be, but are not limited to, information sharing items, and optional items may be, but are not limited to, additional items. In addition, in operation S1260, the vulnerability information sharing apparatus 100 may add each piece of information of the token generated from the vulnerability-detected product name to the information sharing items and the additional items of the generated observed information sharing object. For example, the vulnerability information sharing apparatus 100 may add the observed information to the observed information sharing object according to program code 1300 illustrated in FIG. 13. Then, the vulnerability information sharing apparatus 100 may generate the observed information sharing object as an observed information sharing document in operation S1270. The generated observed information sharing document may be stored in the vulnerability database 110.

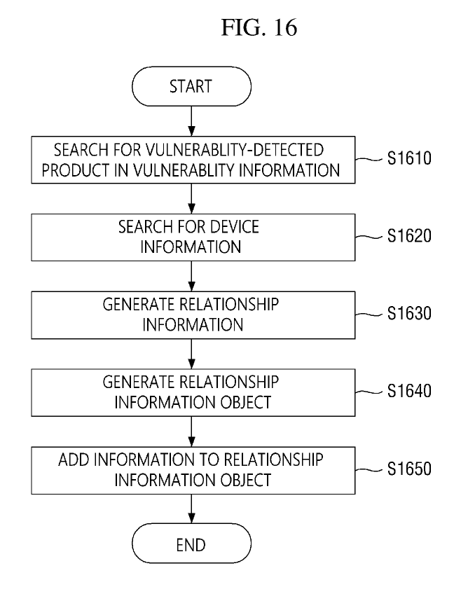

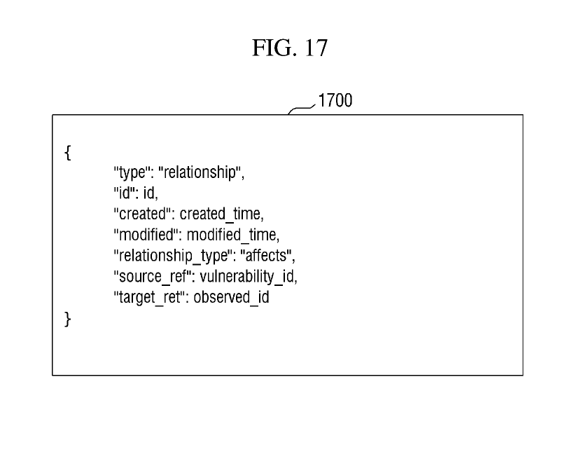

FIG. 16 illustrates a process of generating relationship information according to an embodiment.

According to an embodiment, in operation S1610, the vulnerability information sharing apparatus 100 may search for a vulnerability-detected product in vulnerability information sharing objects. For example, the vulnerability information sharing apparatus 100 may search for a CPE-ID in the vulnerability information sharing objects.

Then, in operation S1620, the vulnerability information sharing apparatus 100 may search for device information based on the vulnerability-detected product found in operation S1610. According to an embodiment, the vulnerability information sharing apparatus 100 may search for an observed information sharing object, which includes information about the vulnerability-detected product found in operation S1610, in observed information sharing objects.

Next, in operation S1630, the vulnerability information sharing apparatus 100 may generate relationship information between vulnerability information and observed information based on the vulnerability information sharing object in which the vulnerability-detected product was found and the found observed information sharing object. According to an embodiment, it is possible to generate relationship information indicating that there is a directional relationship from the vulnerability information to the observed information including information about the vulnerability-detected product included in the vulnerability information.

In addition, according to an embodiment, the vulnerability information sharing apparatus 100 may further generate relationship information between the vulnerability information and other vulnerability information. For example, when the vulnerability information includes an associated CVE-ID, the vulnerability information sharing apparatus 100 may further generate relationship information indicating that the vulnerability information is related to vulnerability information having the associated CVE-ID as a CVE-ID.

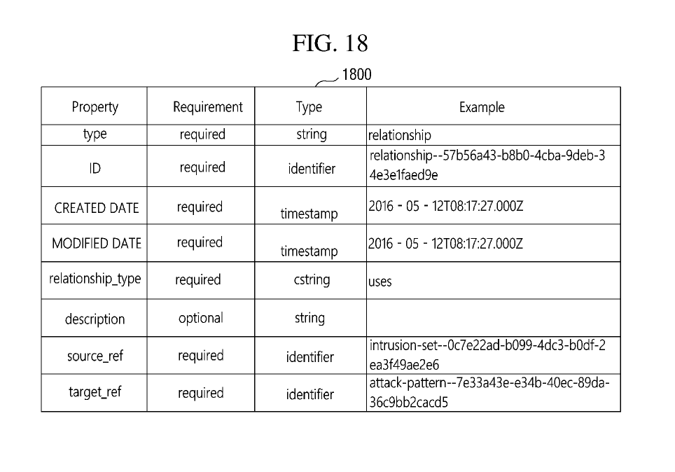

Next, in operation S1640, the vulnerability information sharing apparatus 100 may generate a relationship information sharing object. For example, an information sharing object including items 1800 illustrated in FIG. 18 may be generated.

Next, in operation S1650, the vulnerability information sharing apparatus 100 may add information to the generated relationship information sharing object. For example, the vulnerability information sharing apparatus 100 may add the observed information to the relationship information sharing object according to program code 1700 illustrated in FIG. 17. The vulnerability information sharing apparatus 100 may generate the relationship information sharing object as a relationship information sharing document and store the relationship information sharing document in the vulnerability database 110.

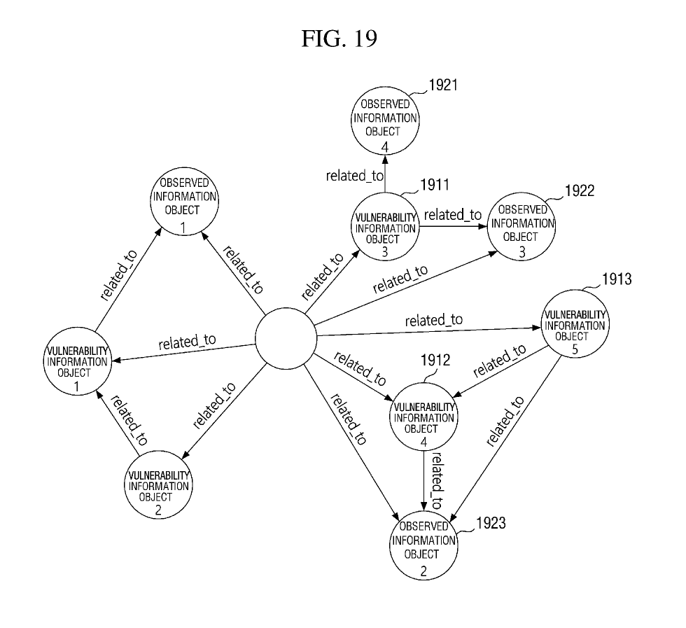

According to an embodiment, the vulnerability database 110 may be a graph database that stores a graph constructed based on a vulnerability information sharing document, an observed information sharing document, and a relationship information sharing document. The vulnerability information sharing apparatus 100 may set each information sharing object as a node and set the relationship between the nodes based on relationship information. The graph constructed based on the information sharing documents may show the nodes and the relationship between the nodes. For example, the vulnerability database 110 may store the graph as in FIG. 19.

Referring to FIG. 19, it can be seen that a third vulnerability information object 1911 is related to two observed information objects (a fourth observed information object 1921 and a third observed information object 1922). In addition, it can be seen that two vulnerability information objects (a fourth vulnerability information object 1912 and a fifth vulnerability information object 1913) are related to a second observed information object 1923 and that the fifth vulnerability information object 1913 is related to the fourth vulnerability information object 1912.

If vulnerability information, observed information, and relationship information are stored in the form of a graph constructed based on information sharing objects as illustrated in FIG. 19, it is possible to easily identify information about an observed device related to vulnerability information or other vulnerability information related to the vulnerability information.

Each component described herein may be implemented as a software component or a hardware component such as a field programmable gate array (FPGA) or application-specific integrated circuit (ASIC). However, the components are not limited to the software or hardware components and may be configured to reside on the addressable storage medium or configured to execute one or more processors. The functionality provided for in the components may be combined into fewer components or further separated into additional components.

The methods according to the embodiments described above can be performed by the execution of a computer program implemented as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program may be transmitted from a first computing device to a second computing device through a network such as the Internet and may be installed in the second computing device and used in the second computing device. Examples of the first computing device and the second computing device include fixed computing devices such as a server, a physical server belonging to a server pool for a cloud service, and a desktop PC. Hence, the computer program can be used in the hardware computing apparatus.

The computer program may be stored in a non-transitory recording medium such as a DVD-ROM or a flash memory.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A vulnerability information providing system comprising:
a vulnerability information analysis system which collects vulnerability information from a source of vulnerability information and collects observed information comprising information about a device related to the vulnerability information;
a vulnerability information sharing apparatus which generates a document for sharing vulnerability information by converting the vulnerability information into a predefined format, converting the observed information obtained by observing the device connected to a network into a predefined format, and generating relationship information between the vulnerability information and the observed information; and
a vulnerability database which stores the document for sharing vulnerability information and provides the document for sharing vulnerability information to a device requesting the vulnerability information.

2. The vulnerability information providing system of claim 1, wherein the vulnerability information sharing apparatus adds additional items for vulnerability information, which does not match predetermined information sharing items, to an Structured Threat Information Expression(STIX) object that defines the predetermined information sharing items according to the predefined format.

3. The vulnerability information providing system of claim 2, wherein the predetermined information sharing items comprise vulnerability ID, reference information, description information, created date information and modified date information, and the additional items comprise vulnerability type, vulnerability score and affected product.

4. The vulnerability information providing system of claim 1, wherein the vulnerability information analysis system determines the source of vulnerability information, searches for a rule for collecting a vulnerability information corresponding to the source of vulnerability information, and collects the vulnerability information according to the found rule for collecting a vulnerability information.

5. The vulnerability information providing system of claim 1, wherein the vulnerability information sharing apparatus generates a STIX object comprising the vulnerability information converted into the predefined format, and the vulnerability database sets the STIX object as a node and stores a graph showing the node and the relationship between the node and another node.

6. The vulnerability information providing system of claim 5, wherein the predefined format is a format based on Structured Threat Information Expression (STIX) which is a language used to exchange Cyber Threat Intelligence (CTI), and the STIX object is a STIX domain object.

7. A method of generating a document for sharing vulnerability information using a computing device, the method comprising:
converting known vulnerability information into a predefined format;
converting observed information, which comprises information about a device related to the vulnerability information, into the predefined format;
generating relationship information between the vulnerability information and the observed information; and
generating a document for sharing vulnerability information comprising the converted vulnerability information, the converted observed information and the relationship information.

8. The method of claim 7, further comprising adding additional items for vulnerability information, which does not match predetermined information sharing items, to a STIX object that defines the predetermined information sharing items according to the predefined format.

9. The method of claim 8, wherein the converting of the vulnerability information into the predefined format comprises:
generating basic vulnerability information for the predetermined information sharing items based on the vulnerability information;
converting the vulnerability information into additional vulnerability information according to a format set in the additional items; and
generating a STIX object and adding the basic vulnerability information and the additional vulnerability information to the STIX object.

10. The method of claim 9, wherein the converting of the vulnerability information into the additional vulnerability information comprises extracting a Common Platform Enumeration (CPE) ID, Common Vulnerabilities Scoring System (CVSS) score information and a Common Weakness Enumeration ID (CWE-ID) from the vulnerability information.

11. The method of claim 9, wherein the generating of the basic vulnerability information comprises:
generating an object ID;
extracting date information and description information from the vulnerability information; and
generating reference information.

12. The method of claim 11, wherein the generating of the reference information comprises:
generating a name of a source of vulnerability information which provides the vulnerability information; and
obtaining a Uniform Resource Locator (URL) which provides the vulnerability information.

13. A vulnerability information sharing apparatus comprising:
a processor;
a storage device which stores a program; and
a memory which stores a plurality of operations to be executed by the processor, wherein the operations comprise:
an operation of converting known vulnerability information into a predefined format;
an operation of converting observed information, which comprises information about a device related to the vulnerability information, into a predefined format;
an operation of generating relationship information between the vulnerability information and the observed information; and
an operation of generating a document for sharing vulnerability information comprising the converted vulnerability information, the converted observed information and the relationship information.

14. A computer program recorded on a non-transitory computer-readable medium and, when instructions of the computer program are executed by a processor of a server, performing operations of:
converting known vulnerability information into a predefined format;
converting observed information, which comprises information about a device related to the vulnerability information, into the predefined format;
generating relationship information between the vulnerability information and the observed information; and
generating a document for sharing vulnerability information comprising the converted vulnerability information, the converted observed information and the relationship information.
